(19) United States
(12) Patent Application Publication
(10) Pub. No.: US 2017/0013596 A1
(43) Pub. Date: Jan. 12, 2017

(54) CONTROL OF SEMI-PERSISTENT CHANNEL OCCUPATION FOR DEVICE-TO DEVICE (D2D) WIRELESS COMMUNICATIONS

(71) Applicant: Nokia Solutions and Networks Oy, Espoo (FI)

(72) Inventors: Vinh van PHAN, Oulu (FI); Ling YU, Oulu (FI); Kari HORNEMAN, Oulu (FI)

(21) Appl. No.: 15/114,355

(22) PCT Filed: Jan. 28, 2014
(86) PCT No.: PCT/EP2014/051604

§ 371 Date: Jul. 26, 2016

(51) Int. Cl. H04W 72/02; H04W 72/04; H04W 72/10; H04W 74/08

(52) U.S. Cl. CPC H04W 72/02; H04W 74/0816; H04W 72/0406; H04W 72/10

(57) ABSTRACT

Various example implementations are provided to improve wireless resource usage in a device-to-device (D2D) wireless network. According to one example implementation, a first user device may transfer a wireless channel to another user device of the D2D user group before an end of a current channel holding period. The first user device may control sending a channel transfer notification. One or more other user devices may request transfer of the channel for a remaining portion of the current channel holding period by controlling sending a channel transfer request to the first user device. According to another example implementation, the first user device may control sending a channel holding period extension request to one or more other user devices of a device-to-device (D2D) user group to request that the first user device continue holding the wireless channel for a next channel holding period.

### TECHNICAL FIELD

This description relates to wireless networks.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period, controlling receiving, by the first user device via the wireless channel from one or more of the other user devices of the user group, a channel transfer request, the channel transfer request comprising information identifying a requesting user device, selecting, among the other user devices by the first user device, a second user device to receive a transfer of the channel for a remaining portion of a current channel holding period, and controlling sending, by the first user device via the wireless channel, a channel transfer response that identifies the selected second user device to which the channel is transferred for a remaining portion of the current channel holding period.

According to an example implementation, the method may further include controlling sending data, by the first user device via the wireless channel, during a first portion of the current channel holding period.

According to an example implementation, the channel transfer notification may include information identifying the first user device and a cause that indicates a cause for the transfer of the wireless channel, the cause identifying at least one of: end of a service/application, an empty buffer, or a low battery condition.

According to an example implementation, the channel transfer notification may include information identifying the first user device, a user group ID to identify the user group, and a resource identification to identify channel resources for a contention window for the first user device to receive channel transfer requests and channel resources for a response window for the first user device to send the channel transfer response.

According to an example implementation, the channel transfer notification may include a resource identification to identify resources for a plurality of request channels that may be used to receive a channel transfer request from one or more of the other user devices.

According to an example implementation, the resource identification identifies resources for a plurality of request channels that include at least one of the following: frequency division multiplexed request channels, time division multiplexed request channels, or code division multiplexed request channels.

According to an example implementation, the selecting may include selecting, by the first user device, one of the other user devices to receive a transfer of the wireless channel based on a transmission priority for each requesting user device.

According to an example implementation, the channel transfer request from the one or more other user devices includes at least information identifying a requesting user device, a buffer status and a transmission priority for the requesting user device, the first user device selecting one of the other user devices to receive the wireless channel based on both the transmission priority and buffer status for the requesting user device.

According to an example implementation, the method further including the first user device performing the following before sending the channel transfer notification: determining that the remaining portion of the current channel holding period is greater than a threshold amount of time.

According to an example implementation, the method further including determining one or more previous channel usage demands of one or more of the other user devices of the user group, and wherein the selecting includes selecting, by the first user device, one of the other user devices to receive a transfer of the wireless channel based on the previous channel usage demands of the other user devices of the user group.

According to an example implementation, a computer program product for a computer is provided that includes software code portions for performing the steps of any of the above methods described herein when the product is run on the computer.

According to an example implementation, an apparatus is provided for carrying out the method according to any one of methods described herein.

According to an example implementation, an apparatus includes at least one processor and at least one memory including computer instructions, when executed by the at least one processor, cause the apparatus to: control sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period, control receiving, by the first user device via the wireless channel from one or more of the other user devices of the user group, a channel transfer request, the channel transfer request including information identifying a requesting user device, selecting, among the other user devices by the first user device, a second user device to receive a transfer of the channel for a remaining portion of a current channel holding period, and control sending, by the first user device via the wireless channel, a channel transfer response that identifies the selected second user device to which the channel is transferred for a remaining portion of the current channel holding period.

According to an example implementation, a computer program product is provided that includes a computer-readable storage medium and storing executable code that, when executed by at least one data processing apparatus, is configured to cause the at least one data processing apparatus to perform a method including controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period, controlling receiving, by the first user device via the wireless channel from one or more of the other user devices of the user group, a channel transfer request, the channel transfer request comprising information identifying a requesting user device, selecting, among the other user devices by the first user device, a second user device to receive a transfer of the channel for a remaining portion of a current channel holding period, and controlling sending, by the first user device via the wireless channel, a channel transfer response that identifies the selected second user device to which the channel is transferred for a remaining portion of the current channel holding period.

According to an example implementation an apparatus may include means for controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period, means for controlling receiving, by the first user device via the wireless channel from one or more of the other user devices of the user group, a channel transfer request, the channel transfer request including information identifying a requesting user device, means for selecting, among the other user devices by the first user device, a second user device to receive a transfer of the channel for a remaining portion of a current channel holding period, and means for controlling sending, by the first user device via the wireless channel, a channel transfer response that identifies the selected second user device to which the channel is transferred for a remaining portion of the current channel holding period.

According to an example implementation a method includes controlling sending, by a first user device via a wireless channel during a current channel holding period, a channel holding period extension request to one or more other user devices of a device-to-device (D2D) user group to request that the first user device continue holding of the wireless channel for a next channel holding period, determining if a channel holding period extension response has been received from at least one of the other user devices of the D2D user group, selecting, by the first user device, the first user device to hold the wireless channel for the next channel holding period if no channel holding period extension responses have been received, otherwise, if one or more channel holding period extension responses have been received from other user devices, then the first user device selecting either the first user device or one of the other user devices that sent a channel holding period extension response to hold the wireless channel for the next channel holding period, and controlling sending, by the first user device via the wireless channel, a channel holding period extension confirmation that identifies the selected user device to hold the wireless channel for the next channel holding period.

According to an example implementation, each of the channel holding period extension responses, if received, include information identifying the responding user device and a transmission priority of the responding user device, and, the selecting includes the first user device selecting the responding user device having a highest transmission priority among the responding user devices.

According to an example implementation, each of the channel holding period extension responses, if received, includes information identifying the responding user device, a transmission priority of the responding use device and a buffer status of the responding user device, and the selecting comprises the first user device selecting one of the responding user devices based on the transmission priority and buffer status of each of the user devices.

According to an example implementation, the channel holding period extension request includes information identifying the first user device and a transmission priority of the first user device, each of the channel holding period extension responses, if received, includes information identifying the responding user device and a transmission priority of the responding user device, and the selecting includes the first user device selecting either the first user device or one of the other user devices that sent a channel holding period extension response based on the transmission priority of each of the user devices.

According to an example implementation, the channel holding period extension request includes information identifying the first user device and a transmission priority of the first user device, and each of the channel holding period extension responses includes information identifying the responding user device and a transmission priority of the responding user device, wherein the channel holding period extension responses are received by the first user device only from responding user devices having a transmission priority that is higher than the first user device.

According to an example implementation, an apparatus includes at least one processor and at least one memory including computer instructions, when executed by the at least one processor, cause the apparatus to: control sending, by a first user device via a wireless channel during a current channel holding period, a channel holding period extension request to one or more other user devices of a device-to-device (D2D) user group to request that the first user device continue holding of the wireless channel for a next channel holding period, determine if a channel holding period extension response has been received from at least one of the other user devices of the D2D user group, select, by the first user device, the first user device to hold the wireless channel for the next channel holding period if no channel holding period extension responses have been received, otherwise, if one or more channel holding period extension responses have been received from other user devices, then the first user device selecting either the first user device or one of the other user devices that sent a channel holding period extension response to hold the wireless channel for the next channel holding period, and control sending, by the first user device via the wireless channel, a channel holding period extension confirmation that identifies the selected user device to hold the wireless channel for the next channel holding period.

According to another example implementation, a computer program product includes a computer-readable storage medium and storing executable code that, when executed by at least one data processing apparatus, is configured to cause the at least one data processing apparatus to perform a method including: controlling sending, by a first user device via a wireless channel during a current channel holding period, a channel holding period extension request to one or more other user devices of a device-to-device (D2D) user group to request that the first user device continue holding of the wireless channel for a next channel holding period, determining if a channel holding period extension response has been received from at least one of the other user devices of the D2D user group, selecting, by the first user device, the first user device to hold the wireless channel for the next channel holding period if no channel holding period extension responses have been received, otherwise, if one or more channel holding period extension responses have been received from other user devices, then the first user device selecting either the first user device or one of the other user devices that sent a channel holding period extension response to hold the wireless channel for the next channel holding period, and controlling sending, by the first user device via the wireless channel, a channel holding period extension confirmation that identifies the selected user device to hold the wireless channel for the next channel holding period.

According to another example implementation, an apparatus includes means controlling sending, by a first user device via a wireless channel during a current channel holding period, a channel holding period extension request to one or more other user devices of a device-to-device (D2D) user group to request that the first user device continue holding of the wireless channel for a next channel holding period, means for determining if a channel holding period extension response has been received from at least one of the other user devices of the D2D user group, means for selecting, by the first user device, the first user device to hold the wireless channel for the next channel holding period if no channel holding period extension responses have been received, otherwise, if one or more channel holding period extension responses have been received from other user devices, then the first user device selecting either the first user device or one of the other user devices that sent a channel holding period extension response to hold the wireless channel for the next channel holding period, and means for controlling sending, by the first user device via the wireless channel, a channel holding period extension confirmation that identifies the selected user device to hold the wireless channel for the next channel holding period.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network 130 according to an example implementation.

FIG. 2 is a diagram illustrating control of a shared channel for a D2D user group 125 according to an example implementation.

FIG. 3 is a timing diagram illustrating operation of user devices within a user group according to an example implementation in which a first user device may transfer the wireless channel to another user device before an end of the current channel holding period.

FIG. 4 is a timing diagram illustrating operation of user devices within a user group according to an example implementation in which a first user device may request and obtain continuing control of the wireless channel for a next channel holding period.

FIG. 5 is a flow chart illustrating operation of a user device according to an example implementation in which a first user device may transfer the wireless channel to another user device before an end of the current channel holding period.

FIG. 6 is a flow chart illustrating operation of a user device according to an example implementation in which a first user device may request and obtain continuing control of the wireless channel for a next channel holding period.

FIG. 7 is a block diagram of a wireless device (e.g., user device, BS or other wireless device) 700 according to an example implementation.

### DETAILED DESCRIPTION

Various example implementations are provided to improve efficiency of wireless resource usage such as in a device-to-device (D2D) or proximity service (ProSe) wireless network. According to one example implementation, a first user device may transfer a wireless channel to another user device of the D2D user group before an end of a current channel holding period. The first user device may control sending a channel transfer notification. One or more other user devices may request transfer of the channel for a remaining portion of the current channel holding period by controlling sending a channel transfer request to the first user device. According to another example implementation, the first user device may control sending a channel holding period extension request to one or more other user devices of a device-to-device (D2D) user group to request that the first user device continue holding the wireless channel for a next channel holding period.

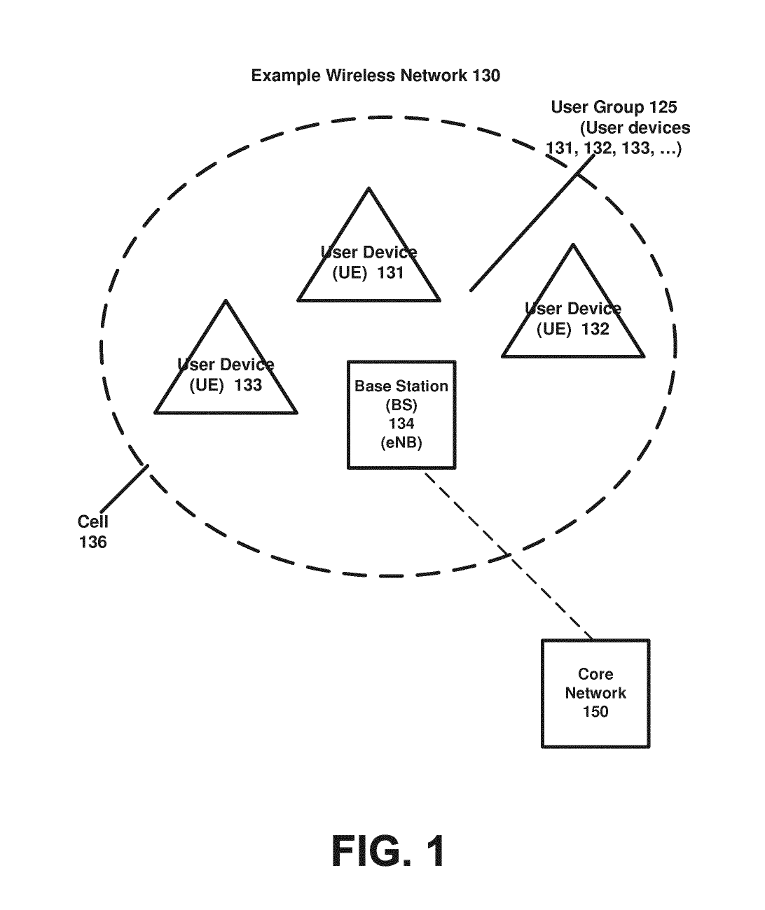

FIG. 1 is a block diagram of a wireless network 130 according to an example implementation. In the wireless network 130 of FIG. 1, user devices 131, 132 and 133, which may also be referred to as user equipments (UEs), may be connected (and in communication) with a base station (BS) 134, which may also be referred to as an enhanced Node B (eNB). At least part of the functionalities of a base station or (e)Node B may be also be carried out by any node, server or host which may be operably coupled to a transceiver, such as a remote radio head. BS 134 provides wireless coverage within a cell 136. Although only three user devices are shown within cell 136 (connected or attached to BS 134), any number of user devicesmay be provided. BS 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE, core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

According to an example implementation, user devices 131, 132, and 133 may be in proximity to each other and may be part of a user group (or cluster) 125. According to an example implementation, the user devices user device of user group 125 may operate in a device-to-device (D2D) mode in which user devices may directly communicate with each other. Thus, in a D2D mode, communications may occur directly between user devices, rather than passing through BS 134, for example. D2D communications may be performed, for example, in the event of a breakage of S1 interface 151 or other network failure. Alternatively, a user group 125 may be established and the user devices 131, 132 and 133 may perform D2D communications even when no such network failure has occurred, such as, for example, to offload traffic from the network (BS 134 and core network 150) and/or to allow user devices to communicate directly in a D2D mode.

According to an example implementation, a semi-persistent resource (e.g., wireless channel(s)) may be allocated to the user group 125 for D2D mode of operation. The allocated channel may be allocated or assigned by BS 134 to members (user devices 131-133) of the user group 125, or may be preconfigured (on each user device) to be used by each user device of the user group 125 in the event that the user devices operate in a D2D mode of operation. Such resource or channel allocation may be considered persistent since it may be assigned to the user group for an extended period of time and does not typically expire, and is semi-persistent since the channel or resource allocated to user group 125 may be changed (or cancelled or re-assigned) by BS 134, for example.

According to an example implementation, user devices within the user group 125, when operating in a D2D mode of operation, may share one or more resources or channels for transmitting to one or more other user devices within the user group. Because of the shared nature of such resource or channel, when one user device is transmitting, 1 or more (or even all) of the other user devices may be receiving the transmitted signal via the shared channel. Thus, such a transmission may be considered as a broadcast transmission, or a 1:M transmission in the D2D mode.

According to one example implementation, a distributed resource allocation technique may be used, where user devices may contend for the right to control the channel. A variety of distributed resource access techniques may be used, such as contention-based access techniques where user devices contend for the right to control the channel or the right to transmit on the channel. One example of a distributed resource access technique that may be used may include a Carrier Sense Multiple Access (CSMA) technique in which a node or user device first senses the channel or medium to determine if another node or user device is transmitting. If the channel is idle, the user device may begin transmitting. If the channel or medium is busy, the user device waits for the channel to become idle. Thus, CSMA may be employ a listen-before-talk or sense-before-transmit technique for user devices to contend for the right to transmit a packet. A number of CSMA variations may be employed, for example, such as a CSMA/collision detection (CSMA/CD) in which performance may be improved by a user device terminating its transmission on the channel as soon as a collision is detected. A CSMA/collision avoidance (CSMA/CA) technique may be used where, for example, a user device may first transmit a request to send (RTS), and then either detect idle channel or wait for a clear to send (CTS) signal, before transmitting on the channel. If the channel is busy, or if no CTS signal is received, then the user device may wait or backoff a random period of time, before sensing the channel and transmitting if channel is idle or upon receipt of a CTS signal. These are just a few example distributed resource allocation techniques, and any resource allocation technique may be used by a user device to obtain control of a channel (or obtain the right to transmit on the channel).

According to an example implementation, a channel that has been allocated to (and is shared among) the user devices of a D2D user group 125 (or cluster) may be divided into channel holding periods. Each channel holding period may be a period of time where the channel may be obtained (e.g., held or occupied) by one of the user devices. According to an example implementation, holding or occupying the channel by a user device may allow the holding user device to transmit data and control signals on the channel, schedule resources for contention windows to allow other user devices to contend to transmit data or signals, and otherwise control the channel for the channel holding period. For example, once a user device obtains (or holds) the shared channel, the (holding) user device may transmit data via the channel to other user devices. The user device that holds the channel may also schedule opportunities or windows during its channel holding period that allow one or more other user devices of the user group 125 to transmit during the channel holding period, for example.

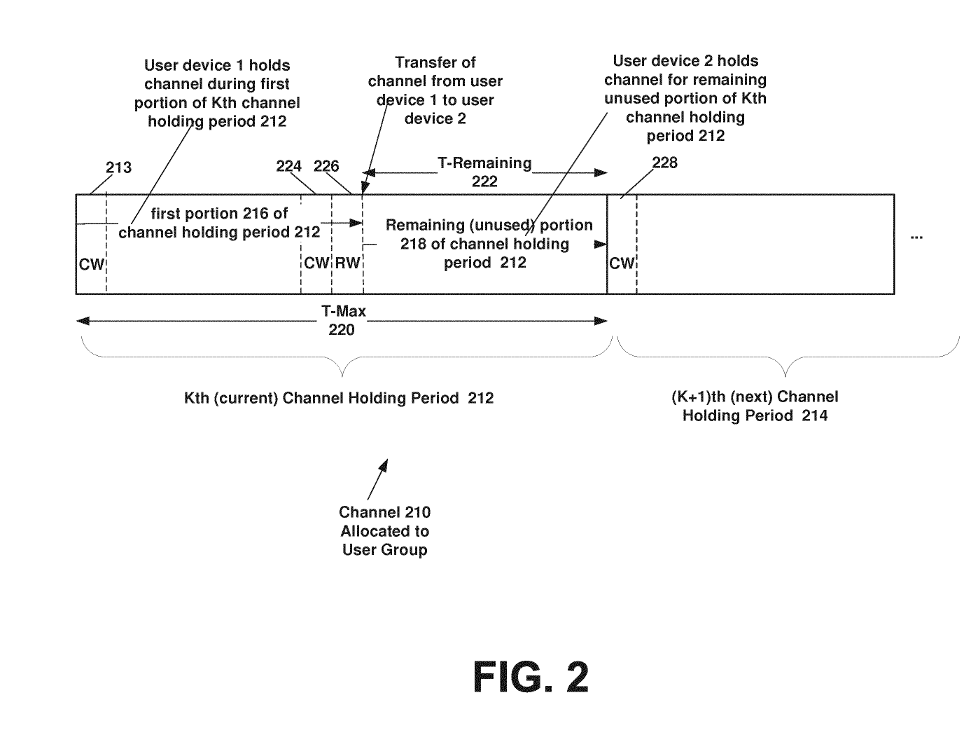

FIG. 2 is a diagram illustrating control of a shared channel for a D2D user group 125 according to an example implementation. Referring to FIG. 2, a channel 210 that has been allocated to user group 125 is illustrated. The channel may be divided in time into a plurality of channel holding periods, where each channel holding period may be long enough, for example, to transmit many packets, or may be hundreds or thousands of time slots in length, for example. These are merely some examples, and other lengths for channel holding periods may be provided.

Channel 210 may include, for example, a Kth channel holding period 212, and a (K+1)th channel holding period 214 (e.g., where channel holding period 214 is the next consecutive channel holding period after channel holding period 212). For this example, the Kth channel holding period 212 may be referred to as the current channel holding period, and the (K+1)th channel holding period 214 may be referred to as the next channel holding period. Also, in this illustrative example, there may be multiple user devices in user group 125, including user devices user device1, user device 2 and user device 3, for example. Each channel holding period may have a length or period (or maximum period) of T-Max 220 (FIG. 2). Alternatively, each channel holding period may have a variable length up to a maximum length or time period of T-Max 220. But, for example, a channel holding period may be shorter than T-Max, e.g., if a user device that is holding the channel releases the channel (without transferring the channel to another user device) before end of the channel holding period.

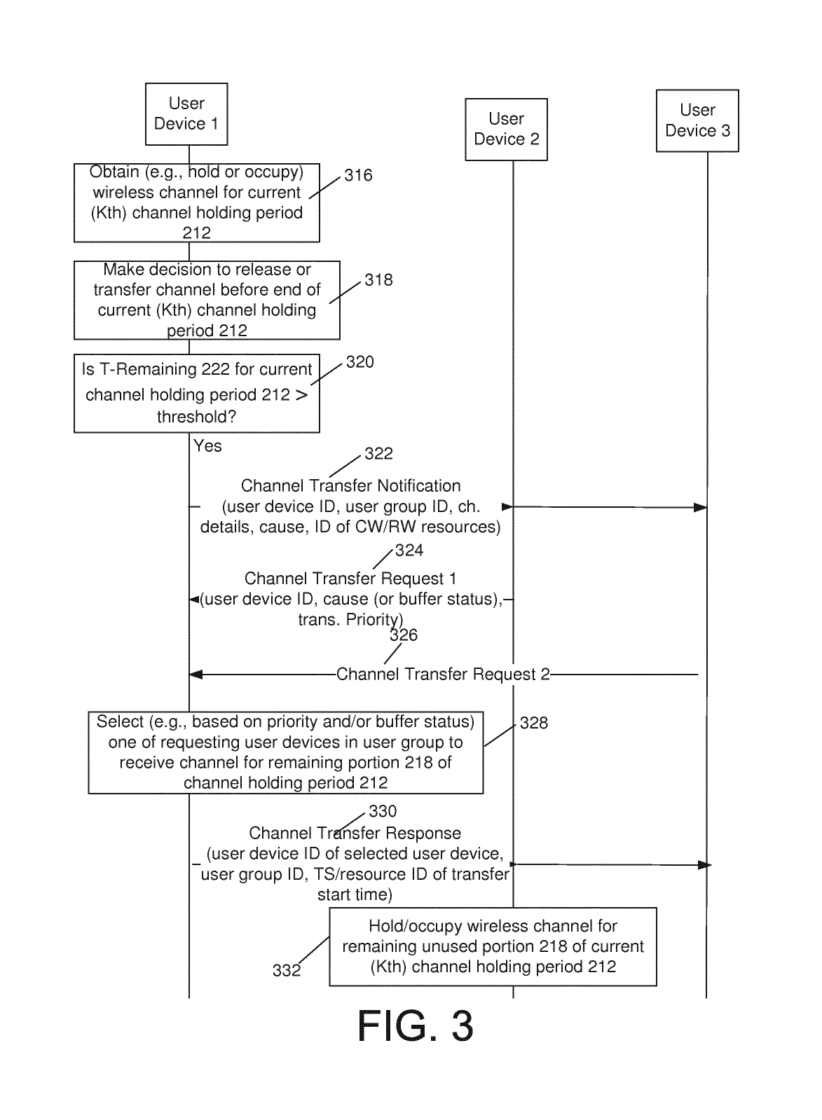

FIG. 3 is a timing diagram illustrating operation of user devices ( ) within a user group 125 according to an example implementation. In FIG. 3, three mobile stations are shown, including user device1, user device 2 and user device 3. The example operation of the user devices of the user group will be described with reference to both FIGS. 2 and 3.

User device 1, for example, may successfully contend for the channel 210 during a contention window (cw) 213 (FIG. 2) and thereby obtain at block 316 (FIG. 3) the channel 210 for the Kth channel holding period 212 (or obtain control of the Kth channel holding period 212). Thus, user device 1 may hold or occupy the channel 210 for the current (Kth) channel holding period 212. In this illustrative example, after obtaining the channel 210, user devicel may, for example, transmit data to other user devices via the channel 210 during a first portion 216 of the Kth channel holding period 212.

As shown by block 318 (FIG. 3), at some point during the first portion 216 of the Kth channel holding period, user devicel may make the decision to release the channel 210 and/or transfer the channel 210 to another user device before the end of the Kth channel holding period 212. There may be a number of different reasons or causes why user devicel may make the decision to transfer control of the channel 210 to another user device before the end of the Kth channel holding period 212, such as, for example, an end or termination of a service or application (e.g., audio or telephone call terminates, video session terminates), an empty data buffer (no more data to transmit) for user device 1, or a low battery condition for user device 1 that dictates that the user devicel should stop transmitting to conserve battery power, for example. These are merely a few examples, and there may be many other causes or reasons for the user devicel to transfer control of channel 210 to another user device before end of the Kth (or current) channel holding period 212.

Before transferring control of the channel 210 to another user device for a remaining portion 218 of the Kth channel holding period 212, user devicel may first determine if it is worthwhile to transfer control of the remaining portion 218 (FIG. 2) of the channel holding period 212. For example, as shown by block 320 (FIG. 3), user devicel may determine whether the remaining (unused) portion 218 (having a length T-Remaining 222, FIG. 2) of the channel holding period 212 is greater than a threshold value. If T-Remaining 222 (the remaining portion 218 of the Kth channel holding period 212) is greater than a threshold value, then the user devicel (the user device that holds or occupies the channel for the current channel holding period 212) may then take steps to perform the transfer of the channel, such as notifying other user devices of the transferability of the channel, obtaining requests from the other user devices, selecting one of the other requesting user devices to receive the transfer of the channel, and then notifying the other user devices of the selected user device to receive transfer of the channel for the remaining portion 218 of the Kth channel holding period 212. In this manner, a transfer of channel 210 for a remaining portion 218 of the current (Kth) channel holding period 212 may be performed before end of the Kth channel holding period 212. According to another example implementation, this transfer of the channel may also be described as transferring control of a remaining portion 218 of the Kth (or current) channel holding period 212 to another user device.

Various techniques, or alternative techniques, may be used to determine if it is worthwhile to transfer the remaining portion of the channel, and/or whether it is worthwhile for a user device in need to request and obtain a transfer of the remaining portion 218 (FIG. 2) of the channel holding period 212. The threshold value (to which T-Remaining 222 is compared), can be given by, e.g., a simple minimum time interval, or a minimum percentage of the current channel holding period, or the amount of minimum throughput the channel should be able to provide within the remaining time T-Remaining 222, as estimated by relevant user device or, that is, the product of the current channel capacity and actual left time T-Remaining taking into account the actual scheduled occasions, radio channel conditions, etc. In this regard, user devices in need of the channel (e.g., user devices having data to transmit), upon receiving the channel transfer notification, may first determine whether the channel is worthwhile or not for itself (e.g., is T-Remaining 222 sufficient to meet the data transmission needs of acquiring user device) and based on that, determines whether to send a channel transfer request 324/326 or not. That is, the threshold value may be pre-configured to all relevant user devices. Also, each user device in need of the channel may determine its own threshold value based on its data transmission needs or other criteria. Therefore, first the user device releasing or transferring the channel (by sending a channel transfer notification 322) may determine whether T-Remaining 222 is sufficient or greater than the threshold value before sending the channel transfer notification, and any other user devices in need of the channel may similarly determine whether T-Remaining 222 would be sufficient for them or would meet their needs (e.g., greater than its own determined threshold value) before transmitting a channel transfer request 324 or 326.

After determining that the channel 210 should be transferred and that it is worthwhile to transfer the channel 210 (e.g., T-Remaining 222 is greater than a threshold), then user devicel (which currently holds the channel) then sends a channel transfer notification (322, FIG. 3) to one or more other user devices of the user group 125 during the first portion 216 of the channel holding period 212. According to an example implementation, the channel transfer notification 322 may notify the other user devices of the D2D user group 125 that the channel 212 is transferrable (or releasable) to another user device (e.g., upon request) before end of the current channel holding period 212.

The channel transfer notification 322 may include one or more fields, such as, for example, information identifying the transmitting user device 1, such as a user device ID to identify the user device that currently holds the channel (e.g., user device ID to identify user device 1), the user group ID to identify the user group (e.g., a user group ID to identify user group 125), a cause that may identify the cause or reason for the early release of the channel 210. Some illustrative causes may include, for example, an end of a service or application, an empty data buffer or no further data to send, or a low battery condition. These are merely some examples, and other causes or reasons for channel transfer may be provided or identified in the cause field. The channel transfer notification 322 may also include an identification of resources within the first portion 216 of the channel holding period 212 (such as time slots of the channel 210 or time slots of the allocated frequency band), including, for example, an identification of resources for a contention window (cw) 224 (FIG. 2) where the other user devices may submit channel transfer requests and an identification of a response window (rw) 226 (FIG. 2) where the other user devices may receive a channel transfer response 330 (e.g., that identifies a selected user device to receive the channel 210) from the user device currently holding the channel (user device 1).

In addition, the channel transfer notification 322 may also include channel details that describe or identify the channel 210 (or identify the portion of the channel holding period 212) that is being transferred. For example, the channel details may identify a channel number, frequency or carrier for the channel 210, an identification of the start and/or end of the remaining portion 218 of the channel holding period 212 that is being transferred, which may be a start and/or end time or starting/ending time slot(s) for the remaining portion 218. For example, at least in some cases, the starting and ending points or time slots for each of the channel holding periods may be already known by each of the user devices of the user group 125. Therefore, the start of the remaining portion 218 that is being transferred may be provided or identified in some cases. These are merely some examples of the fields that may be included in the channel transfer notification 322, and other or different fields may be included.

In response to receiving the channel transfer notification 322, one or more other user devices within the user group 125 may, for example, determine if the remaining portion of the current channel holding period is sufficient to meet the needs of the user device (e.g., greater than a threshold value). This threshold value may be the same threshold value as used by user device that currently holds the channel, or may be a different threshold value specific to the needs of the user device in need of the channel. If the remaining portion of the current channel holding period is sufficient, then the user device in need may contend for the channel 210 during the scheduled contention window (cw) 224 and send a channel transfer request to the user device that currently holds the channel (user devicel) in order to request a transfer of the channel 210 for the remaining portion 218 of the current (Kth) channel holding period 212. For example, as shown in FIG. 3, user device 2 may send a channel transfer request 1 324, and user device 3 may send a channel transfer request 2 326, which may be received by user device 1. Each channel transfer request (e.g., channel transfer requests 324, 326, . . . ) may include a message with one or more fields. Alternatively, a channel transfer request may simply be a preamble signal, e.g., in the event that no particular fields need to be communicated within the channel transfer request.

For example, each of the requesting user devices may employ one of the carrier sense multiple access (CSMA) techniques to sense the channel 210, and then transmit the channel transfer request. The requesting user device may continue sensing or listening to the medium or wireless channel 210 while transmitting, and may stop transmitting and perform a random backoff or random wait period before transmitting again if a collision is detected on the channel. For example, user devices having a lower transmission priority may wait or perform a random backoff for a longer period of time, as compared to higher priority user device, in the event that the channel is busy or a collision is detected. This is merely one illustrative example of a technique that may be used by user devices within D2D user group to contend for (or obtain) access to the channel 210 for transmitting the channel transfer request. Other techniques may be used.

In another alternative implementation, the contention window (cw) 224 may be divided into multiple transmission opportunities, to allow different user devices to use different transmission opportunities, e.g., to reduce the probability or likelihood of a collision. Transmission opportunities may be time division multiplexed, frequency division multiplexed, or code division multiplexed. Thus, these different transmission opportunities may be provided by multiplexing these opportunities in time (e.g., different time slots or symbols for different transmission opportunities), frequency (different carrier frequencies for different transmission opportunities) or by code (different codes for different transmission opportunities). The different transmission opportunities may be assigned to each user device, or an user device may randomly select one of the opportunities to transmit its channel transfer request, e.g., in order to reduce the probability of a collision with another channel transfer request. According to an example implementation, one or more opportunities for transmitting a channel transfer request (e.g., a different time slot or symbols, a different frequency, or a different code) may be assigned to user devices or identified by the user device 1 (that currently holds the channel) within a field of the channel transfer notification 322.

Each of the channel transfer requests may include one or more fields, such as, for example information to identify the requesting user device (e.g., user device ID), a user group ID to identify the user group, a cause for requesting transfer such as a buffer status, and a transmission priority for the requesting user device or a transmission priority of an application of the requesting user device. These are merely examples, and other fields may be provided.

After receiving one or more channel transfer requests (e.g., requests 324, 326), at operation 328 (FIG. 3), the user device that currently is holding the channel (e.g., 3 5 user device 1) may select one of the requesting user devices to receive (a transfer of the channel or) the channel 210 for the remaining portion 218 of the current channel holding period 212. The currently holding user device (user device 1) may select one of the requesting user devices based on a variety of criteria. For example, a requesting user device may be selected that has the highest priority (or highest transmission priority), or the user device having the fullest buffer (e.g., as indicated by buffer status that indicates a percent fullness of a data buffer of the requesting user device). Or, a user device may be selected based on transmission priority as a primary criteria, and then buffer status as a secondary criteria that is considered if multiple user devices have the same transmission priority, for example. Thus, in such an example, one of the requesting user devices may be selected that has a highest transmission priority. If the requesting user devices indicate the same transmission priority, then the user device having the highest level of buffer fullness may be selected to receive the channel transfer, for example. These are merely some examples, and other criteria may be used.

According to an example implementation, if no channel transfer requests are successfully received by the controlling user device, the controlling user device may select one of the other user devices based on prior traffic demands or channel usage demands of the user devices.

After selecting one of the requesting user devices to receive control of the remaining portion 218, the user device 1 sends a channel transfer response 330 (FIG. 3) within the response window 226. The channel transfer response 330 informs the user devices of the user group 125 of the user device that has been selected to receive (the transfer of) the channel 210 for the remaining portion 218 of the current channel holding period 212. Therefore, according to an example implementation, the channel transfer response 330 may include one or more fields, such as a user group ID to identify the user group, information identifying the user device that is currently holding the channel (e.g., user device ID to identify user device 1) and information identifying the selected user device (such as a user device ID to identify device2 or user device3). The channel transfer response 330 may also identify the resources or the starting resources (e.g., starting point/time or first time slot) for the remaining portion 218 of the channel holding period 212 that is being transferred to the new controlling user device. This starting point or starting resource ID for the remaining portion 218 may identify the starting point when the selected user device will obtain the channel 210 for the remaining portion of the channel holding period 212 (or obtain the remaining portion 218 of channel holding period 212). At operation 332, the selected user device (e.g., user device 2) which received the channel 210 or received transfer of the channel 210 holds or occupies the wireless channel 210 for the remaining portion 218 of the current channel holding period 212.

According to an example implementation, if no channel transfer request is received within a timeout period (e.g., by the end of the cw 224), the operation 320 (determining whether T-Remaining 222 is greater than a threshold) and operation 322 (sending an channel transfer notification 322) may be repeated, and the user device that currently holds the channel (e.g., user device 1) may again listen for channel transfer requests during the indicated contention window 224. Eventually, a user device may be able to successfully contend for the channel 210 during the scheduled contention window 224 and send the channel transfer request which is received by user device 1. Otherwise, if the T-Remaining 222 is less than the threshold at operation 320, then the transfer of the channel 210 for the remaining portion 218 of the channel holding period 212 may be abandoned or terminated by user device 1, e.g., since the remaining portion 218 may not be sufficient enough to justify the signaling overhead to perform the transfer of the remaining portion 218 of the current channel holding period 212. In such case, according to an example implementation, the user device currently holding the channel (e.g., user device 1) may release the channel early and allow user devices to contend for the next channel holding period.

According to another example implementation, a channel transfer request may be coupled to or transmitted with data, e.g., provided that other user devices in the user group 125 are receiving or listening to the data transmission at that time. Thus, for example, a user device may transmit a channel transfer request, and if no collision is detected by the transmitting user device, the transmitting may include following the transmission of the channel transfer request immediately with a transmission of data. Thus, in such case, the requesting user device may assume that it has been selected to control the remaining portion 218 of the channel holding period 212 if no collision is detected, and the user device immediately begins transmitting data after transmitting the channel transfer request, e.g., as the selected user device for the remaining portion 218 of the channel holding period 212.

According to an example implementation, regardless whether a user device is able to receive a transfer of the channel 210 for a remaining portion 218 of the current channel holding period 212, the user devices of the user group 125 may be able to contend for control of a next (K+1)th channel holding period 214 during contention window (cw) 228 for the next channel holding period 214. For example, contention window 228 may be provided between the current channel holding period 212 and next channel holding period 214, or may be considered a beginning or starting portion of the next channel holding period 214. Thus, in such an example implementation, user devices may contend (or use other resource allocation technique) to obtain each channel holding period.

However, according to another (alternative) example implementation, if a user device (a new controlling user device) successfully receives control of a remaining portion 218 of the current (Kth) channel holding period 212 via channel transfer, then that new controlling user device will also automatically control the next channel holding period 214. Thus, in such an example implementation, when the new controlling user device is selected to receive control of the channel 210 for a remaining portion 218 of the current channel holding period 212, this also operates to select such new controlling user device to control the next channel holding period 214.

According to another example implementation, user device1 may determine that the channel (e.g., at least for the current channel holding period) is underutilized by itself (e.g., its traffic demands need only a portion of the channel capacity). Therefore, in such a case, where the channel is under-utilized by the current holder of the channel (e.g., based on user device 1 determining that it has used less than a threshold amount of the channel capacity, or that the user device 1 has little or no further data to transmit), it may be desirable to allow other user devices within the user group to share the channel with it over the remaining portion 218 of the current channel holding period 212. Thus, instead of issuing a channel transfer notification (322), the user device that currently holds the channel (e.g., user device 1) may issue a channel underutilized notification (similar to the channel transfer notification 322), specifying channel details, cause, cw/rw resources, to the user group. Other user devices in need of the channel (e.g., having data to be transmitted), upon reception of the channel underutilized notification, may send channel sharing request(s), similar to channel transfer request 324, 326, to user device1. User device1 may then make a decision to allocate some unused portion of the channel resources (e.g., all or part of the remaining unused portion 218 of the channel holding period 212) under its control to one or more selected other user devices by issuing a channel sharing response, which may identify the allocated resources and the other user device to which the resources have been allocated for transmission. In an example implementation, user device 1 may still hold or occupy or control the channel for the channel holding period, and has allocated a portion of such remaining portion 218 to allow increased channel utilization. The sharing in time may be especially preferable for broadcast-based group communications but sharing in other dimensions such as frequency is also foreseen.

In general, each user device may be able to contend for control of each channel holding period, e.g., during a contention window 213 or 228 (as examples) or via some other resource allocation technique. In this manner, a fair resource sharing or other resource allocation technique that allows some type of sharing of the channel/resource among multiple users/user devices may be provided. According to another example implementation, user device currently holding the channel (e.g., user device 1, FIG. 2) may have additional data to send at the end of the current channel holding period 212. In other words, the user device currently holding the channel 210 (e.g., user device 1) may have more data to send/transmit than what can be sent via the current channel holding period 212. In such a case, the user device 1 may be able to request (via a channel holding period extension request), a continued holding of the channel for the next channel holding period 214 before the end of the current channel holding period 212. In some situations, based on the request and possible responses from other user devices, the user device currently holding the channel (e.g., user device 1) may be able to obtain (or continue) control of the channel 210 for the next channel holding period 214.

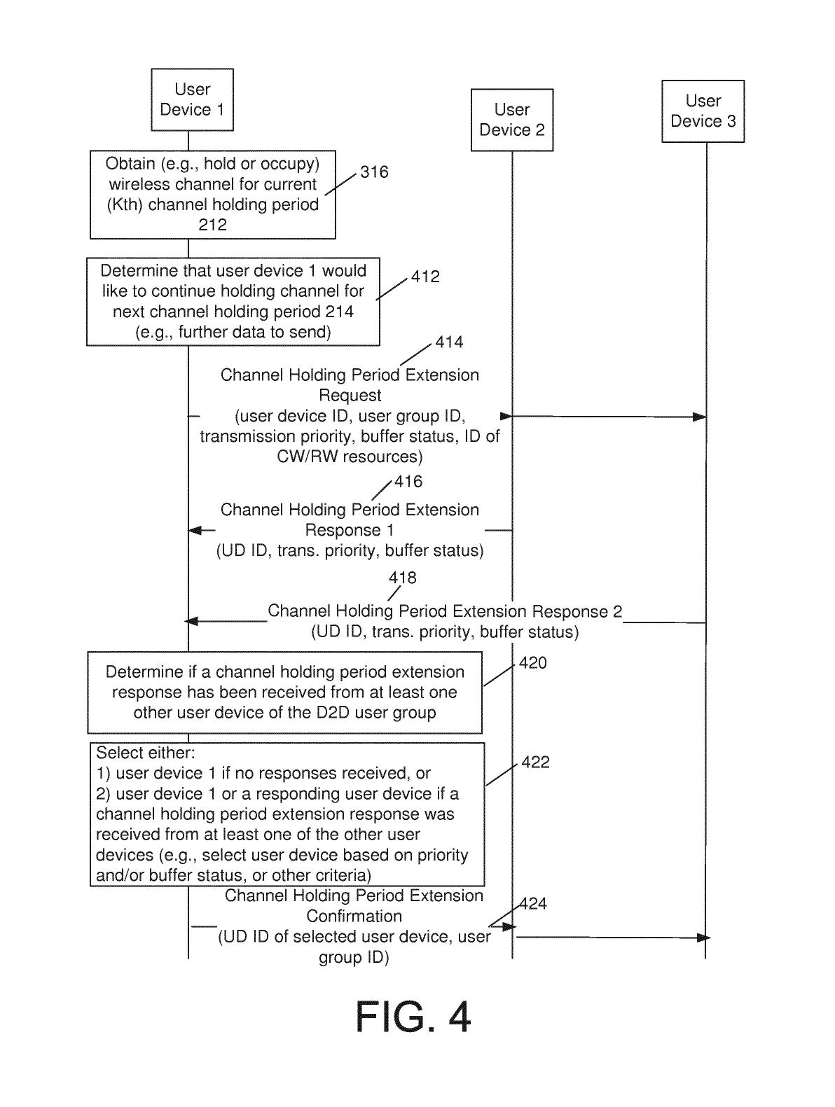

FIG. 4 is a diagram illustrating operation of a user device (user devicel) that holds or occupies a current channel holding period 212 and sends a request to other user devices to continue holding the next channel holding period according to an example implementation. With reference to FIG. 4, at 316, the user devicel obtains the wireless channel for the current (Kth) channel holding period. Therefore, the user device 1 holds or occupies the channel for the current channel holding period. At 412, user devicel may then determine that it would like to continue holding the channel 210 (FIG. 2) for the next channel holding period 214 (FIG. 2), e.g., based on additional data that the user device 1 would like to send. In other words, for example, the current channel holding period 212 may be insufficient to send all the data that the user device 1 would like to send.

Therefore, the user devicel sends or transmits a channel holding period extension request 414 to one or more other user devices of the D2D user group 125, e.g., to user device 2 and user device 3 as shown in FIG. 4, in order to request that the user device that currently holds the channel (e.g., user devicel) continue (or extend) holding the wireless channel 210 for a next channel holding period 214. According to an example implementation, to avoid contention or possible interference, such channel holding period extension request 414 should be sent within the current channel holding period 212 while the current controlling user device has control over the channel 210. The channel holding period extension request 414 may include several fields, such as, for example, information (e.g., a user device ID) identifying identify the transmitting/requesting user device, a transmission priority (e.g., indicating a priority of the requesting user device 1 or of an application of the user device 1) and a buffer status (e.g., indicating an amount of fullness of the transmission buffer(s)) for the transmitting/requesting user device 1. The channel holding period extension request 414 may also identify resources (e.g., time slots) for a contention window (cw 224) and a response window (rw 226).

The other user devices (e.g., user device 2, user device 3, . . . ) of the user group 125 may receive the channel holding period extension request 414. In response to receiving the channel holding period extension request 414, each of the other user devices (e.g., user device 2, user device 3) may determine if they would like or need to obtain control of the channel 210 (e.g., if the user device has data for transmission) for the next channel holding period 214. If the other user device (e.g., user device 2 and/or user device 3) has data they would like to transmit or otherwise would like to obtain control of the channel 210 for the next channel holding period 214, then such user device (user device 2 or user device 3) may contend for the channel 210 and may send or transmit a channel holding period extension response, such as channel holding period extension responses 416 and 418 from user device 2 and user device 3, respectively, during the scheduled contention window (cw) 224 over the channel 210, for example.

According to yet another example implementation, the other user devices (e.g., user device 2 or user device 3) that have data for transmission or otherwise would like to control the channel 210 for the next channel holding period 214 may compare the transmission priority (or simply priority) of the user device that currently holds the channel 210 (as indicated by the channel holding period extension request 414) and/or the transmission priority of other user devices (based on their channel holding period extension responses), to their own transmission priority. According to an example implementation, the other user device (e.g., user device 2 or user device 3) may send its channel holding period extension response 416 or 418 only if its priority is higher or greater than the priority of the holding user device (e.g., user devicel) and/or higher than any other user devices that have already transmitted a channel holding period extension response (or otherwise advertised or indicated their priority/transmission priority). Buffer status and/or other criteria may be used instead of transmission priority. Therefore, this technique may provide further efficiency, e.g., by avoiding the possible contention, transmission, receiving and/or processing of channel holding period extension responses that would be (or would have been) rejected by the currently holding user device (user device 1) as having a lower priority, and/or lesser buffer status (or other criteria) that is less or lower priority than the user device that is currently holding the channel (e.g., user device 1) or other user device that has sent a channel holding period extension response.

Each of these channel holding extension responses may include several fields such as, for example, information identifying the responding/transmitting user device (e.g., user device ID), a buffer status, and a transmission priority of the responding/transmitting user device. As noted, the channel holding period extension response(s), if any, may be sent during a scheduled contention window (e.g., cw 224, FIG. 2), scheduled by the user device that is currently holding the channel. According to an example implementation, if the other user device (e.g., user device 2 or user device 3) does not have data for transmission for the next channel holding period 214, then such user device does not transmit a channel holding period extension response.

At 420, user device 1 determines if a channel holding period extension response has been received from at least one other user device of the D2D user group.

At 422, user device 1 may select a user device to control the channel for the next channel holding period 214, e.g., based on whether a channel holding period extension response was received. For example, user device 1 may select user device 1 (itself) to hold the channel 210 for the next channel holding period 214 if no channel holding period extension responses were received during such contention window 224. In other words, if no channel holding period extension responses (e.g., responses 416, 418, FIG. 4) are received by the user device currently holding the channel, then the user device currently holding the channel may assume that no other user devices are requesting control of the channel 210 for the next channel holding period 214, and the user device currently holding the channel (e.g., user device 1) may select itself to hold (or continue holding) the channel 210 for the next channel holding period 214.

According to an example, implementation, if one or more channel holding extension responses are received by the controlling user device, then the controlling user device may select a user device, either itself or one of the other user devices, based on transmission priority and/or buffer status of the user devices, or other criteria. For example, the user device 1 may select a user device (e.g., either itself or one of the other user devices that submitted a response 416 or 418) that has a highest transmission priority, or has a fullest transmission buffer as indicated by buffer status, or based on other selection criteria. Therefore, according to an example implementation, the user device currently holding the channel (e.g., user devicel) may simply select, among itself and any user devices that sent a channel holding period extension response, the user device that has the highest priority, or has the fullest transmission buffer, or based on other criteria.

Therefore, in this manner, according to an example implementation, the current holding user device (based upon request 414) may typically be selected to control the channel 210 for the next channel holding period 214 (e.g., to continue or extend its holding of the channel 210), unless there is another user device having a same or higher priority that is also requesting the channel 210 for the next channel holding period 214.

After selecting a user device (either itself or another user device, e.g., based on transmission priority) to hold the channel 210 for the next channel holding period 214, the currently holding user device then sends a channel holding period extension confirmation 424 (or confirmation message), e.g., via the scheduled response window (rw 226). The channel holding period extension confirmation 424 identifies the selected user device to hold the wireless channel 210 for the next channel holding period 214. The channel holding period extension confirmation 424 may include one or more fields, such as information identifying the user device that currently holds the channel (e.g., user device ID for user device 1), information identifying the selected user device, a user group ID, and possibly other fields.

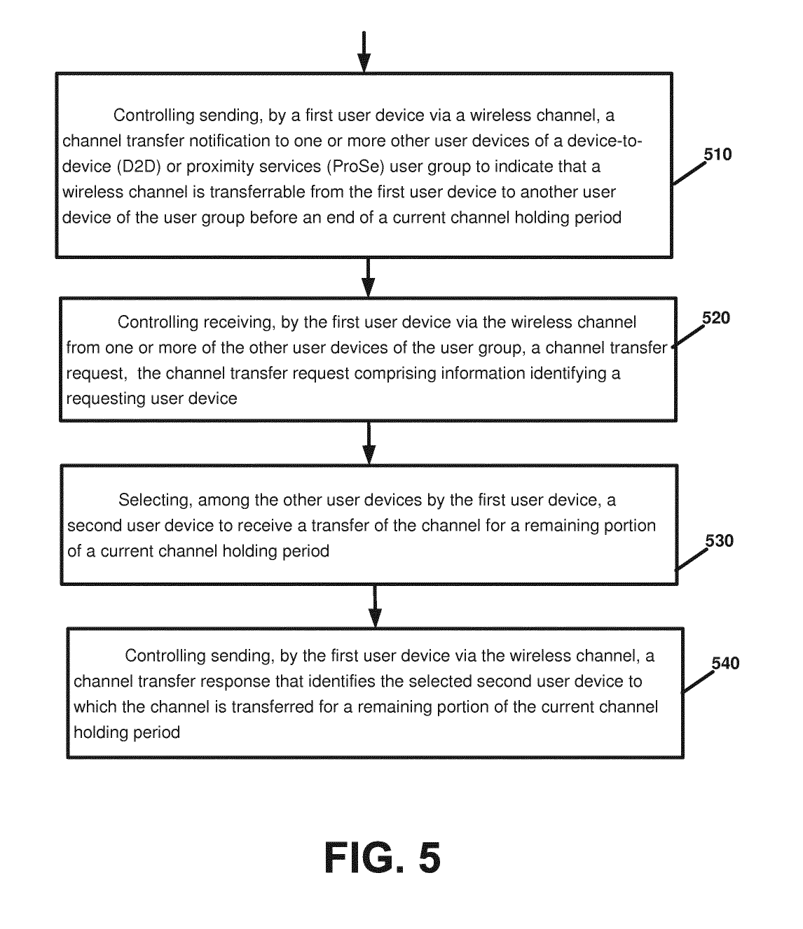

FIG. 5 is a flow chart illustrating operation of a mobile station (user device) according to an example implementation in which a user device may transfer the wireless channel to a new user device before an end of the current channel holding period. Operation 510 includes controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period. Operation 520 includes controlling receiving, by the first user device via the wireless channel from one or more of the other user devices of the user group, a channel transfer request, the channel transfer request comprising information identifying a requesting user device. Operation 530 includes selecting, among the other user devices by the first user device, a second user device to receive a transfer of the channel for a remaining portion of a current channel holding period. And, operation 540 includes controlling sending, by the first user device via the wireless channel, a channel transfer response that identifies the selected second user device to which the channel is transferred for a remaining portion of the current channel holding period.

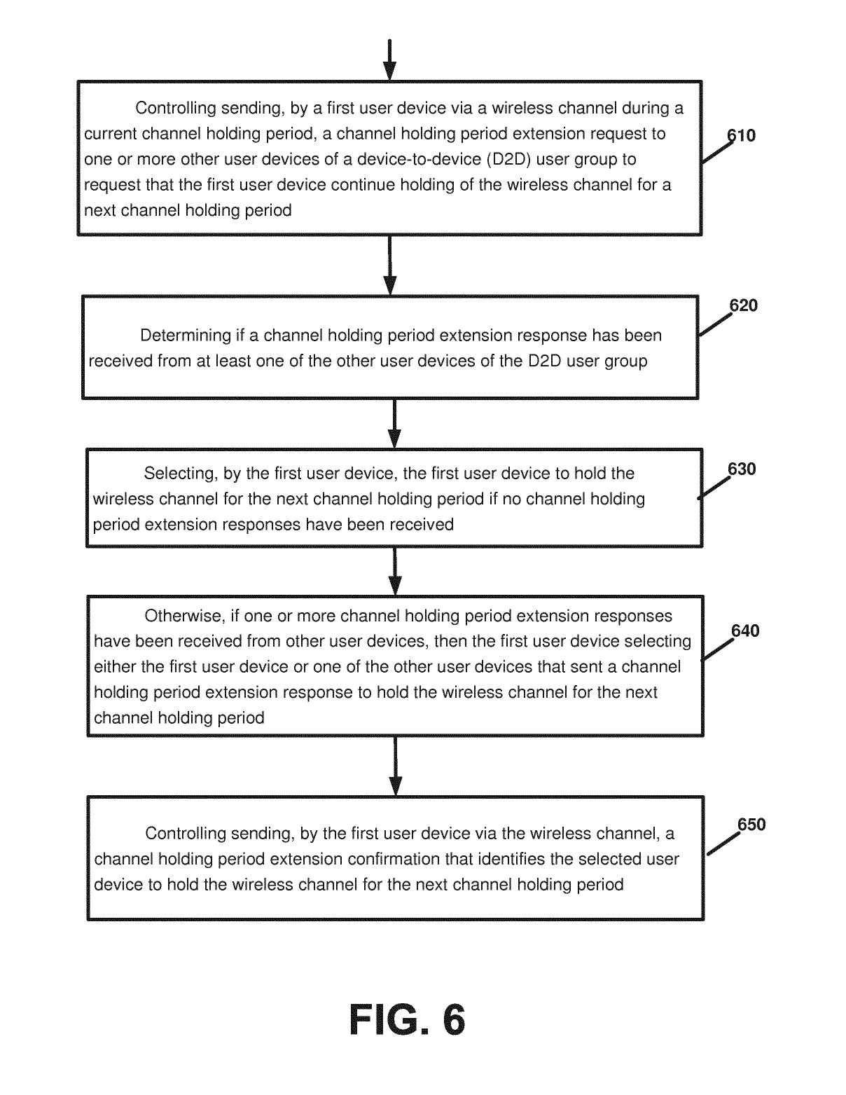

FIG. 6 is a flow chart illustrating operation of a user device according to an example implementation in which user device holding the wireless channel for a current channel holding period may request and obtain continued holding of the wireless channel for a next channel holding period. Operation 610 includes controlling sending, by a first user device via a wireless channel during a current channel holding period, a channel holding period extension request to one or more other user devices of a device-to-device (D2D) user group to request that the first user device continue holding of the wireless channel for a next channel holding period. Operation 620 includes determining if a channel holding period extension response has been received from at least one of the other user devices of the D2D user group. Operation 630 includes selecting, by the first user device, the first user device to hold the wireless channel for the next channel holding period if no channel holding period extension responses have been received. At operation 640, otherwise, if one or more channel holding period extension responses have been received from other user devices, then the first user device selects either the first user device or one of the other user devices that sent a channel holding period extension response to hold the wireless channel for the next channel holding period. Operation 650 includes controlling sending, by the first user device via the wireless channel, a channel holding period extension confirmation that identifies the selected user device to hold the wireless channel for the next channel holding period.

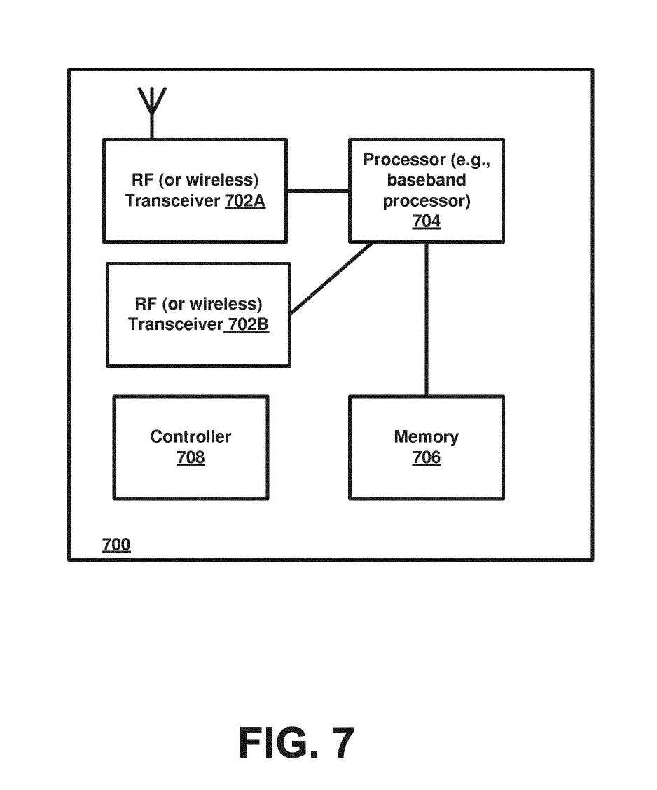

FIG. 7 is a block diagram of a wireless station (e.g., BS or user device) 700 according to an example implementation. The wireless station 700 may include, for example, two RF (radio frequency) or wireless transceivers 702A, 702B, where each wireless transceiver includes a transmitter to transmit signals and a receiver to receive signals. The wireless station also includes a processor or control unit/entity (controller) 704 to execute instructions or software and control transmission and receptions of signals, and a memory 706 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames or other signals for transmission via wireless transceiver 702. Processor 704 may control transmission of signals or messages over a wireless network, and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example implementation, RF or wireless transceiver(s) 702A/702B may receive signals or data and/or transmit or send signals or data. Processor 704 may control the RF or wireless transceiver 702A or 702B to receive, send or transmit signals or data.

According to an example implementation, an apparatus may include means for controlling sending (e.g., processor 704 controlling RF or wireless transceiver 702A/702B), by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period, means for controlling receiving (e.g., processor 704 controlling RF or wireless transceiver 702A/702B), by the first user device via the wireless channel from one or more of the other user devices of the user group, a channel transfer request, the channel transfer request comprising information identifying a requesting user device; means for selecting (e.g., processor 704 or controller 708), among the other user devices by the first user device, a second user device to receive a transfer of the channel for a remaining portion of a current channel holding period; and means for controlling sending (e.g., processor 704 controlling RF or wireless transceiver 702A/702B), by the first user device via the wireless channel, a channel transfer response that identifies the selected second user device to which the channel is transferred for a remaining portion of the current channel holding period.

According to another example implementation, an apparatus may include means for controlling sending (e.g., processor 704 controlling RF or wireless transceiver 702A/702B), by a first user device via a wireless channel during a current channel holding period, a channel holding period extension request to one or more other user devices of a device-to-device (D2D) user group to request that the first user device continue holding of the wireless channel for a next channel holding period, means for determining (e.g., processor 704 and/or controller 708) if a channel holding period extension response has been received from at least one of the other user devices of the D2D user group, means 3 5 for selecting (e.g., processor 704 and/or controller 708), by the first user device, the first user device to hold the wireless channel for the next channel holding period if no channel holding period extension responses have been received, otherwise, if one or more channel holding period extension responses have been received from other user devices, then the first user device selecting either the first user device or one of the other user devices that sent a channel holding period extension response to hold the wireless channel for the next channel holding period; and means for controlling sending (e.g., processor 704 controlling RF or wireless transceiver 702A/702B), by the first user device via the wireless channel, a channel holding period extension confirmation that identifies the selected user device to hold the wireless channel for the next channel holding period.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

Further more, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-24. (canceled)

25. A method comprising:
controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period;
controlling receiving, by the first user device via the wireless channel from one or more of the other user devices of the user group, a channel transfer request, the channel transfer request comprising information identifying a requesting user device;
selecting, among the other user devices by the first user device, a second user device to receive a transfer of the channel for a remaining portion of a current channel holding period; and
controlling sending, by the first user device via the wireless channel, a channel transfer response that identifies the selected second user device to which the channel is transferred for a remaining portion of the current channel holding period.

26. The method of claim 25 and further comprising controlling sending data, by the first user device via the wireless channel, during a first portion of the current channel holding period.

27. The method of claim 25 wherein the channel transfer notification comprises user device information identifying the first user device and a cause that indicates a cause for the transfer of the wireless channel, the cause identifying at least one of: end of a service/application, an empty buffer, or a low battery condition.

28. The method of claim 25 wherein the channel transfer notification comprises information identifying the first user device, a user group ID to identify the user group, and a resource identification to identify channel resources for a contention window for the first user device to receive channel transfer requests and channel resources for a response window for the first user device to send the channel transfer response.

29. The method of claim 25 wherein the channel transfer notification comprises a resource identification to identify resources for a plurality of request channels that may be used to receive a channel transfer request from one or more of the other user devices.

30. The method of claim 25 wherein the channel transfer notification comprises a resource identification to identify resources for a plurality of request channels that may be used to receive a channel transfer request from one or more of the other user devices and wherein the resource identification identifies resources for a plurality of request channels that include at least one of the following: frequency division multiplexed request channels, time division multiplexed request channels, or code division multiplexed request channels.

31. The method of claim 25 wherein the selecting comprises selecting, by the first user device, one of the other user devices to receive a transfer of the wireless channel based on a transmission priority for each requesting user device.

32. The method of claim 25 wherein the channel transfer request from the one or more other user devices includes at least information identifying a requesting user device, a buffer status and a transmission priority for the requesting user device, the first user device selecting one of the other user devices to receive the wireless channel based on both the transmission priority and buffer status for the requesting user device.

33. The method of claim 25 and further comprising the first user device performing the following before sending the channel transfer notification:
determining that the remaining portion of the current channel holding period is greater than a threshold amount of time.

34. The method of claim 25 and further comprising:
determining one or more previous channel usage demands of one or more of the other user devices of the user group; and
wherein the selecting comprises selecting, by the first user device, one of the other user devices to receive a transfer of the wireless channel based on the previous channel usage demands of the other user devices of the user group.

35. The method of claim 25 wherein the channel transfer notification comprises one or more of the following:
a channel number, frequency or carrier for the channel;
an identification of a start and/or end of the remaining portion of the channel holding period; or
a start time and end time for the remaining portion of the channel holding period.

36. An apparatus comprising at least one processor and at least one memory including computer instructions, when executed by the at least one processor, cause the apparatus to:
controlling sending, by a first user device via a wireless channel, a channel transfer notification to one or more other user devices of a device-to-device (D2D) or proximity services (ProSe) user group to indicate that a wireless channel is transferrable from the first user device to another user device of the user group before an end of a current channel holding period;
controlling receiving, by the first user device via the wireless channel from one or more of the other user devices of the user group, a channel transfer request, the channel transfer request comprising information identifying a requesting user device;
selecting, among the other user devices by the first user device, a second user device to receive a transfer of the channel for a remaining portion of a current channel holding period; and
controlling sending, by the first user device via the wireless channel, a channel transfer response that identifies the selected second user device to which the channel is transferred for a remaining portion of the current channel holding period.

37. The apparatus of claim 36, wherein the computer instructions, when executed by the at least one processor, further cause the apparatus to:
send data, by the first user device via the wireless channel, during a first portion of the current channel holding period.

38. The apparatus of claim 36 wherein the channel transfer notification comprises user device information identifying the first user device and a cause that indicates a cause for the transfer of the wireless channel, the cause identifying at least one of: end of a service/application, an empty buffer, or a low battery condition.

39. The apparatus of claim 36 wherein the channel transfer notification comprises information identifying the first user device, a user group ID to identify the user group, and a resource identification to identify channel resources for a contention window for the first user device to receive channel transfer requests and channel resources for a response window for the first user device to send the channel transfer response.

40. An apparatus comprising at least one processor and at least one memory including computer instructions, when executed by the at least one processor, cause the apparatus to:
control sending, by a first user device via a wireless channel during a current channel holding period, a channel holding period extension request to one or more other user devices of a device-to-device (D2D) or proximity services (ProSe) user group to request that the first user device continue holding of the wireless channel for a next channel holding period;
determine if a channel holding period extension response has been received from at least one of the other user devices of the D2D or ProSe user group;
select, by the first user device, the first user device to hold the wireless channel for the next channel holding period if no channel holding period extension responses have been received;
otherwise, if one or more channel holding period extension responses have been received from other user devices, then select by the first user device either the first user device or one of the other user devices that sent a channel holding period extension response to hold the wireless channel for the next channel holding period; and
send, by the first user device via the wireless channel, a channel holding period extension confirmation that identifies the selected user device to hold the wireless channel for the next channel holding period.

41. The apparatus of claim 40 wherein:
each of the channel holding period extension responses, if received, comprises information identifying the responding user device and a transmission priority of the responding user device; and
the selecting by the first user device either the first user device or one of the other user devices comprises the first user device selecting the responding user device having a highest transmission priority among the responding user devices.

42. The apparatus of claim 40 wherein:
each of the channel holding period extension responses, if received, comprises information identifying the responding user device, a transmission priority of the responding use device and a buffer status of the responding user device; and
the selecting by the first user device either the first user device or one of the other user devices comprises the first user device selecting one of the responding user devices based on the transmission priority and buffer status of each of the user devices.

43. The apparatus of claim 40 wherein:
the channel holding period extension request comprises information identifying the first user device and a transmission priority of the first user device;
each of the channel holding period extension responses, if received, comprises information identifying the responding user device and a transmission priority of the responding user device; and
the selecting by the first user device either the first user device or one of the other user devices comprises the first user device selecting either the first user device or one of the other user devices that sent a channel holding period extension response based on the transmission priority of each of the user devices.

44. The apparatus of claim 40 wherein:
the channel holding period extension request comprises information identifying the first user device and a transmission priority of the first user device;
each of the channel holding period extension responses comprises information identifying the responding user device and a transmission priority of the responding user device, wherein the channel holding period extension responses are received by the first user device only from responding user devices having a transmission priority that is higher than the first user device.
